(19) United States
(12) Patent Application Publication
(10) Pub. No.: US 2003/0152693 A1
(43) Pub. Date: Aug. 14, 2003

(54) Methods of applying a coating to an optical surface

(76) Inventors: Kai C. Su, Alpharetta, GA (US); Richard Lu, Alpharetta, GA (US); William M. Hung, Alpharetta, GA (US); Guigui Wang, Cumming, GA (US)

Correspondence Address: William H. Needle, Esq., NEEDLE & ROSENBERG, P.C., The Candler Building, Suite 1200, 127 Peachtree Street, N.E., Atlanta, GA, 30303-1811, US

(21) Appl. No.: 10/075,637

(22) Filed: Feb. 12, 2002

(51) Int. Cl. B05D 5/06; B05D 3/00

(52) U.S. Cl. 427/162; 427/551; 118/620; 118/200; 118/641

(57) ABSTRACT

A method for applying a coating to an optical surface of an optical device. In one embodiment, the method includes the steps of placing a coating solution in a cliche of a cliche plate, transferring the coating solution from the cliche to deformable body of a transfer pad, and pressing the transfer pad to the optical surface so as to transfer the coating solution from the deformable body of the transfer pad to the optical surface. The method further includes a step of irradiating the coating solution associated with the optical surface at a wavelength of microwave so as to form a coating layer on the optical surface. The coating layer can be further cured to form a desired coating on a proper optical surface. The optical device can be an optical lens having at least one optical surface, or a mold that can be used to produce an optical lens. In other words, the present invention allows a coating to be applied directly to an optical surface of an optical lens. Alternatively, a coating can be first applied to an optical surface of at least one mold and then be transferred to an optical surface of an optical lens during casting process.

### BACKGROUND OF THE INVENTION

1. Field of the Invention

The present invention relates to a method for applying a coating to an optical surface. In particular, the present invention relates to a method of applying a coating to an optical surface of an optical device, where the optical surface can be concave or convex and the optical device can be an optical lens or a mold to produce an optical lens.

2. Background

Plastic lenses have over time become desirable for use in making optical lenses, especially of the kind useful for eyeglasses. Plastic lenses offer several advantages over glass lenses, including reduced weight, increased strength and easy to make. To form a plastic lens, two molds, often referred as a front mold and a back mold in the art of lens making, are used. Each mold has a facing inside surface which is referred to as an optical surface as well. When these two molds are properly positioned at a desired distance and rotational orientation to each other, their facing inside surfaces are a negative image of the surfaces of the lens to be formed. A closure member is used to necessarily seal the cavity. Then a fluid lens-forming mixture, normally a liquid monomer, is placed and contained in the cavity defined by the two molds and the closure member. Once the fluid lens-forming mixture is in the cavity, it is cured to form a hardened polymeric lens taking the shape of the molds. The surfaces of the lens are the optical surfaces of the lens.

Generally, plastic lenses for eyewear have been formed from diethylene glycol bis(allylcarbonate) (“DAC”) which has been polymerized via free radical polymerization. DAC lenses offer relatively high impact resistance, light weight, ease of machining and polishing, and ease of dyeing. However, DAC lenses do not offer desirable abrasion resistance.

Plastic lenses can also be produced by molding of thermal plastic resins, such as polymethyl methacrylate (PMMA) and polycarbonate. However, both types of lenses have inherent drawbacks: PMMA lenses offer poor impact resistance while polycarbonate lenses offer inadequate abrasion resistance as well as solvent resistance.

One way the art has sought to improve abrasion resistance for plastic lenses includes applying a hard coating on the surfaces of the lenses through thermal curing or UV radiation curing.

In addition to improve abrasion resistance for plastic lenses, coating can also be used for improving other properties of plastic lenses such as a protective screen for sun light.

Currently, there are several ways or methods in the art to apply coating to optical lenses. One is to apply coating to optical lenses during the casting process. In this option, referring to FIG. 1, lens casting molds F (front mold) and B (back mold) and a gasket G cooperate to form a lens casting apparatus A. Coating solution C can be first applied onto the facing inside or optical surfaces of the molds F and G, respectively, by dipping, spraying or spin coating. The molds F and B are positioned within the gasket G so that a molding cavity MC is formed therebetween the molds F and B, where a lens forming solution such as a lens forming monomer is introduced. When the lens forming solution is cured to form an optical lens (not shown), the coating solution is cured together with the lens forming solution and transferred to the optical surfaces of the optical lens from the molds F and B to form a coating therein.

Alternatively, coating can be applied to the surfaces of an optical lens after the lens casting process by dipping the lens directly into a coating solution, spraying a coating solution to the surfaces of an optical lens or spin coating the surfaces of an optical lens.

However, these coating processes are often time consuming and have practical limitations because each of them is difficulty to control, wasteful and thus expensive. Moreover, dirts may be introduced during the coating process into the coating solution or the lens forming solution to cause optical defect in the resultant lens. Furthermore, each traditional coating process may have its own special limitations, such as in the case for spin coating, where it is difficult to apply a coating onto a convex surface of an optical lens.

Additionally, it is difficult in these coating processes to control uniformness of a coating, especially when the coating needs to be thick and/or the optical surface has a large curvature. Often, as shown in FIG. 14A, the coating solution C distributed by these coating processes over the optical surfaces forms a coating layer in drops of coating solution that has a rough surface and a plurality of holes between the drops. The art refers to this as an “orange-peel like” effect, which has long bothered the art without a satisfactory solution.

Thus, there is a need in the art for a new coating process and apparatus that may provide a well-defined coating to an optical surface, concave or convex, cost-effectively and efficiently.

### SUMMARY OF THE INVENTION

The present invention overcomes the disadvantages of the prior art and revolutionizes the optical-coating process. In one aspect, the present invention relates to a method for applying a coating to an optical surface of an optical device. In one embodiment, the method includes the steps of placing a coating solution in a cliche of a cliche plate, transferring the coating solution from the cliche to a deformable body of a transfer pad, and pressing the transfer pad to the optical surface so as to transfer the coating solution from the deformable body of the transfer pad to the optical surface. The method further includes a step of irradiating the coating solution associated with the optical surface at a wavelength of microwave so as to form a coating layer on the optical surface. The coating layer can be further cured to form a desired coating on a proper optical surface. The optical device can be an optical lens having at least one optical surface, or a mold that can be used to produce an optical lens. In other words, the present invention allows a coating to be applied directly to an optical surface of an optical lens. Alternatively, a coating can be first applied to an optical surface of at least one mold and then be transferred to an optical surface of an optical lens during casting process.

Moreover, a reservoir containing the coating solution is provided and the cliche of the cliche plate can be filled with the coating solution from the reservoir. In one embodiment, the reservoir has a body with a first end and a second end, an outer surface and a longitudinal axis, and defining an axially extending bore, a cap closing the extending bore at the first end, and a wiper blade surrounding the extending bore at the second end. The cliche of the cliche plate can be filled with the coating solution from the reservoir by positioning the reservoir with its second end against the surface of the cliche plate having the cliche such that the cliche plate cooperates with the wiper blade to close the extending bore at the second end, and moving the cliche plate relative to the reservoir in a direction substantially perpendicular to the longitudinal axis so that the wiper blade crosses the cliche to leave the coating solution in the cliche. The reservoir can also have an inlet through the cap and in fluid communication with the bore and a supply of the coating solution so that a coating solution can be introduced to the bore of the reservoir from the supply of the coating solution through the inlet.

Furthermore, in one embodiment of the present invention, the coating solution can be transferred from the cliche to a transfer pad by placing the transfer pad in a first position, positioning the cliche plate in a second position, wherein the first position and the second position are aligned along a first operating axis, bringing the transfer pad and the cliche plate together in a relative movement so that the transfer pad contacts the coating solution in the cliche, pressing the transfer pad against the cliche plate so that some coating solution is transferred from the cliche to form a layer of the coating solution on the transfer pad, separating the transfer pad and the cliche plate from each other in a relative movement so that the transfer pad is substantially back to or stays at the first position and the cliche plate is substantially back to or stays at the second position, and retracting the cliche plate to a retracted position from the second position, wherein the second position and the retracted position are aligned along a second operating axis, and the first operating axis and the second operating axis are substantially perpendicular to each other. Thereafter, a coating solution can be placed similarly in the cliche of the cliche plate in the retraced position, and the cliche plate having the coating solution in the cliche can be again positioned in the second position ready for transferring the coating solution to the transfer pad.

Additionally, in one embodiment of the present invention, the coating solution can be transferred from the transfer pad to the optical surface by placing the transfer pad in a first position, positioning the optical device in a second position, wherein the first position and the second position are aligned along a first operating axis, bringing the transfer pad and the optical device together in a relative movement so that the transfer pad contacts the optical surface of the optical device, and pressing the transfer pad against the optical device so that some coating solution is transferred from the transfer pad to form a layer of the coating solution on the optical surface of the optical device. The transfer pad and the optical device can then be separated from each other in a relative movement so that the transfer pad is substantially back to the first position. The optical device can be subsequently moved to a third position for further irradiating treatment.

In one embodiment of the present invention, if the optical device is an optical lens, the coating layer can be further cured to form a coating on the optical surface by radiation outside the wavelength range of microwave. The radiation source can include an infra-red light, an ultra-violet light, or any combination of them. One surprising discovery of the present invention is that irradiating microwave radiation to the coating solution prior to curing yields a much smoother coating on the optical surface and eliminates the orange-peel like effect of the coating.

If the optical device is one of a front mold or a back mold, wherein the front mold has a facing inside surface, and the back mold has a facing inside surface, the coating solution can be transferred from the transfer pad to each of the facing inside surface, to form a coating layer on each of the facing inside surfaces, respectively. Each coating later can then be irradiated with a radiation at a wavelength of microwave. The front mold and the back mold whose facing inside surfaces are a negative image of the surfaces of an optical lens to be formed are positioned at a proper distance and rotational orientation relative to each other. Next, the edges of the front mold and back mold are closed with a closure member such as a gasket, a sleeve or a wrap to define a molding cavity. A fluid lens-forming material can then be introduced into the molding cavity. The fluid lens-forming material now can be cured by radiation so that the fluid lens-forming material is hardened to form the optical lens and each of the coating layers on the inside surfaces of the front mold and back mold is transferred to and hardened to be bond on a corresponding surface of the optical lens. The radiation source for the curing process can include an infra-red light, an ultra-violet light, or any combination of them.

In another embodiment of the present invention, a screen can be placed over the optical surface prior to the transfer pad is pressed against the optical surface. Some coating solution can be applied to the screen. The transfer pad can then be pressed against the screen so as to transfer the coating solution from the transfer pad to the screen and to the optical surface. The screen has a frame defining an opening, and a film covering the opening, wherein at least part of the film has a plurality of holes. The film in one embodiment includes a partially coated fibre that allows coating solution to pass through under a controlled rate. When the transfer pad is pressed against the screen, the film curvingly fits to the optical surface and causes the coating solution from the transfer pad to reach the optical surface through the plurality of holes, which results a coating layer having a uniform thickness.

In a further aspect, the present invention relates to a method for applying a coating to an optical lens having a first optical surface and a second optical surface. In one embodiment, the method includes the steps of transferring a coating solution to a first transfer pad and a second transfer pad, and pressing the first transfer pad to the first optical surface, and the second transfer pad to the second optical surface, respectively, so as to transfer the coating solution from the first transfer pad and the second transfer pad to the first optical surface and the second optical surface, respectively. The coating solution can be placed in a cliche of a first and a second cliche plates, and the coating solution can be transferred from the cliche of the first cliche plate to the first transfer pad, and from the cliche of the second cliche plate to the second transfer pad, respectively.

In another aspect, the present invention relates to a method for applying a coating to applying a coating to an optical surface of an optical lens. In one embodiment, the method includes the steps of placing a coating solution in a cliche of a cliche plate, transferring the coating solution from the cliche to a transfer pad, pressing the transfer pad to the optical surface so as to transfer the coating solution from the transfer pad to the optical surface, irradiating the coating solution associated with the optical surface at a wavelength of microwave so as to form a coating layer on the optical surface, and curing the coating layer to form a coating on the optical surface by radiation outside the wavelength range of microwave.

In yet another aspect, the present invention relates to a method for applying a coating to applying a coating to at least one optical surface of an optical lens. In one embodiment, the method includes the steps of placing a coating solution in a cliche of a cliche plate, transferring the coating solution from the cliche to a transfer pad, providing a front mold and a back mold each having a facing inside surface, pressing the transfer pad to each of the facing inside surfaces of the front mold and back mold so as to transfer the coating solution from the transfer pad to each of the facing inside surfaces, respectively, irradiating the coating solution associated with each of the facing inside surfaces at a wavelength of microwave so as to form a coating layer on each of the facing inside surfaces, positioning the front mold and the back mold whose facing inside surfaces are a negative image of the surfaces of an optical lens to be formed at a proper distance and rotational orientation relative to each other, both the front mold and back mold having an edge, closing the edges of the front mold and back mold with a closure member to define a molding cavity, injecting a fluid lens-forming material into the molding cavity, and curing the fluid lens-forming material by radiation outside the wavelength range of microwave so that the fluid lens-forming material is hardened to form the optical lens and each of the coating layers on the inside surfaces of the front mold and back mold is transferred to and hardened to be bond on a corresponding surface of the optical lens.

In a further aspect, the present invention relates to a method for applying a coating to applying a coating to at least one optical surface. In one embodiment, the method includes the steps of transferring a coating solution to the optical surface, and irradiating the coating solution at a wavelength of microwave so as to form a coating layer on the optical surface. The method may further include the step of curing the coating layer to form a coating on the optical surface by radiation at a wavelength outside the wavelength range of microwave, wherein the microwave radiation is generated from a microwave energy source, and the radiation at a wavelength outside the wavelength range of microwave is generated by at least one of an ultra-violet light and an infra-red light.

In yet a further aspect, the present invention relates to an apparatus for applying a coating to applying a coating to at least one optical surface. In one embodiment, the apparatus includes means for transferring a coating solution to the optical surface, and means for irradiating radiation at a wavelength of microwave so as to form a coating layer on the optical surface. The apparatus may further include means for curing the coating layer to form a coating on the optical surface by radiation at a wavelength outside the wavelength range of microwave. In one embodiment, the irradiating means may include a microwave energy source such as a microwave oven, and the curing means may include at least one of an ultra-violet light and an infra-red light.

In another aspect, the present invention relates to a method for applying a coating to applying a coating to at least one optical surface. In one embodiment, the method includes the steps of placing a screen over the optical surface, applying some coating solution to the screen, transferring some coating solution to a transfer pad, pressing the transfer pad against the screen so as to transfer the coating solution from the transfer pad to the screen and to the optical surface, and irradiating the coating solution so as to form a coating layer on the optical surface.

These and other aspects will become apparent from the following description of the various embodiments taken in conjunction with the following drawings, although variations and modifications may be effected without departing from the spirit and scope of the novel concepts of the disclosure.

### BRIEF DESCRIPTION OF THE FIGURES OF THE DRAWINGS

FIG. 1 is a cross-sectional view of a prior art coating process to apply a coating to an optical lens during the casting process.

FIG. 2 is a perspective view of an apparatus for applying a coating to an optical surface according to the present invention.

FIG. 3 is a cross-sectional view of part of the apparatus for applying a coating to an optical surface as shown in FIG. 2.

FIG. 3A schematically shows a transfer pad that can be utilized in the apparatus of FIG. 2 according to one embodiment of the present invention.

FIG. 3B is a cross-sectional view of the transfer pad as shown in FIG. 3A.

FIG. 3C schematically shows a transfer pad that can be utilized in the apparatus of FIG. 2 according to another embodiment of the present invention.

FIG. 3D is a cross-sectional view of the transfer pad as shown in FIG. 3C.

FIG. 4 is a cross-sectional view of a transfer pad applying a coating to an optical surface in one embodiment of the present invention.

FIG. 5 is a cross-sectional view of a transfer pad applying a coating to an optical surface in an alternative embodiment of the present invention.

FIGS. 6A-6F schematically show a process of using a transfer pad to apply a coating to an optical surface in one embodiment of the present invention.

FIG. 7 is a perspective view of a coating station used in one embodiment of the present invention.

FIG. 8 schematically shows a process of applying a coating to an optical surface in an automation line in another embodiment of the present invention.

FIG. 9 is a side view of applying a coating to an optical device from both sides in an embodiment of the present invention.

FIG. 10 is a side view of curing the optical device of FIG. 9.

FIG. 11 is a side view of applying a coating to an optical device when the cliche and the reservoir are in a relative motion in one embodiment of the present invention.

FIG. 12A is a perspective view of a coating screen used in one embodiment of the present invention.

FIG. 12B is a top view of the coating screen of FIG. 12A.

FIGS. 13A-13B schematically show a process of using a transfer pad and the coating screen of FIG. 12A to apply a coating to an optical surface in one embodiment of the present invention.

FIG. 14A is a cross-sectional view of a coating applied to an optical surface according to a prior art coating process having an orange-peel like surface.

FIG. 14B is a cross-sectional view of a coating applied to an optical surface according to one embodiment of the present invention having a smoother surface.

### DETAILED DESCRIPTION OF THE INVENTION

The present invention is more particularly described in the following examples that are intended as illustrative only since numerous modifications and variations therein will be apparent to those skilled in the art. As used in the specification and in the claims, “a” can mean one or more, depending upon the context in which it is used. Several embodiments are now described with reference to the figures, in which like numbers indicate like parts throughout the figures. Subtitles, if any, are provided for helping a reader to understand various embodiments and are not intended to limit upon the scope of the invention.

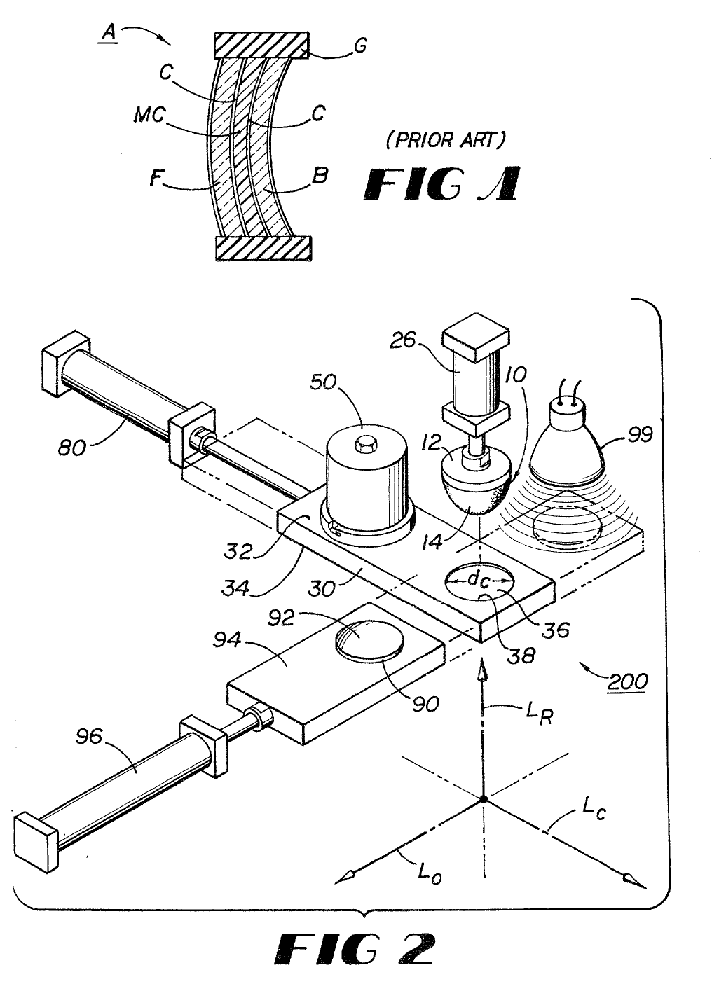

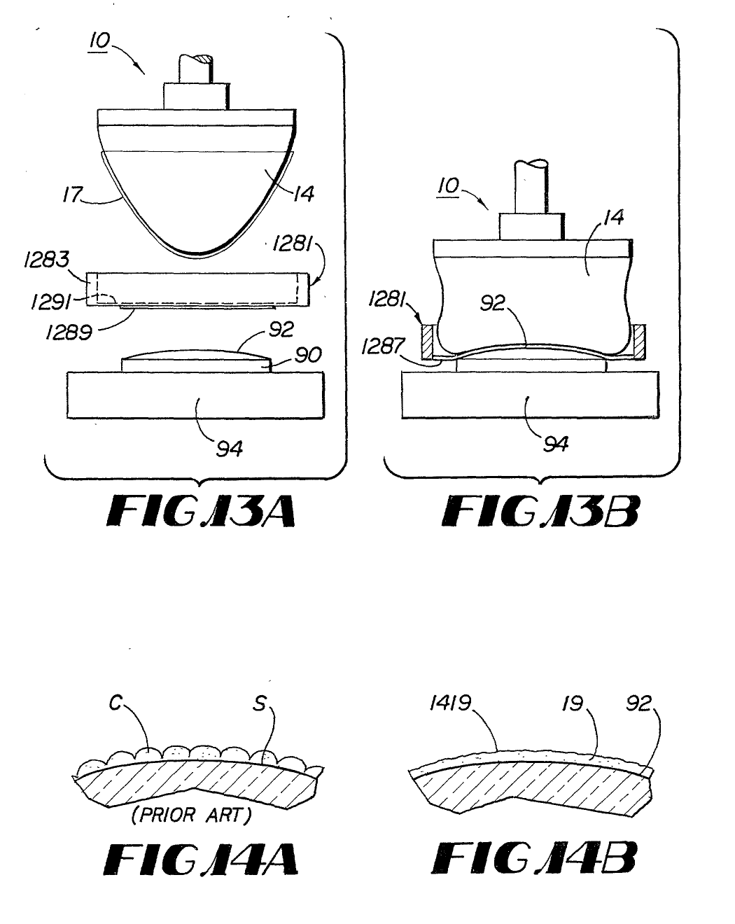

Referring generally to FIGS. 2-14 the present invention comprises a method of applying a coating to an optical surface. The optical surface can be associated with an optical lens, or an optical mold that can be utilized to cast or produce an optical lens.

### The Apparatus of the Present Invention

The apparatus of the present invention can be used to apply a coating to an optical surface having any surface geometry. Referring first to FIGS. 2-5, the present invention relates to an apparatus 200 for applying a coating to an optical surface. In one embodiment, the apparatus 200 includes a transfer pad 10. The transfer pad 10 has a base 12, and a body 14 connected to the base 12. The body 14 can have a bottom 16, a top 18, and a surface 20 connecting the bottom 16 and the top 18. Cross-sectionally, the surface 20 of the body 14 can be any geometric shape such as annular, oval, elliptic, rectangular, square, polygonal, or the like. The surface 20 of the body 14 may also be irregular.

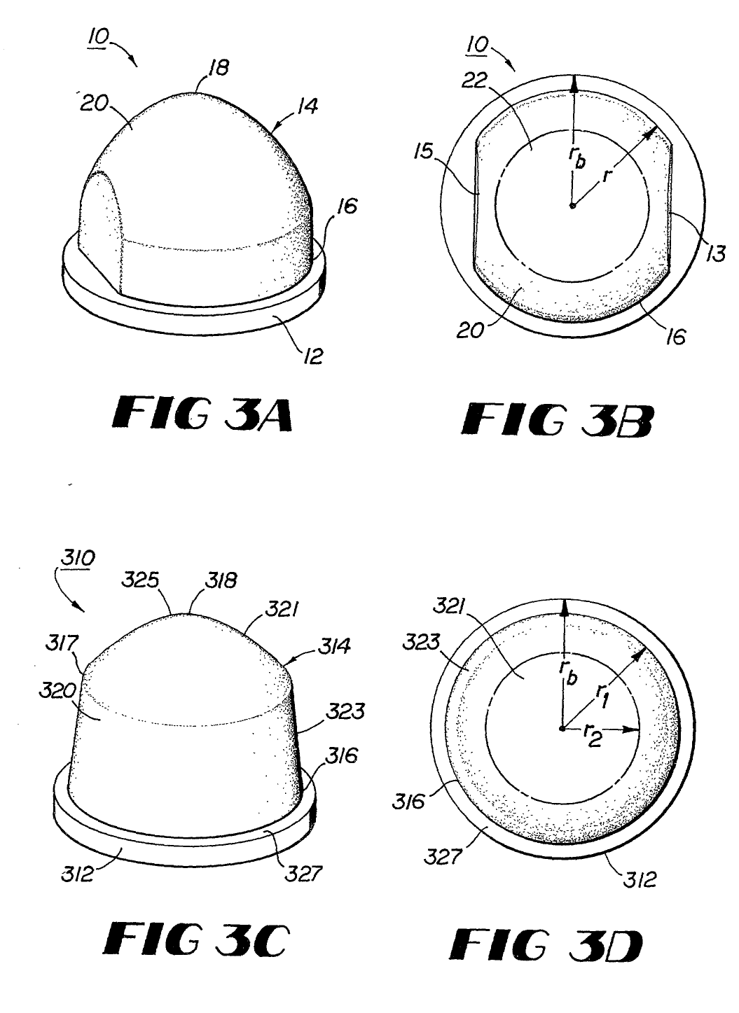

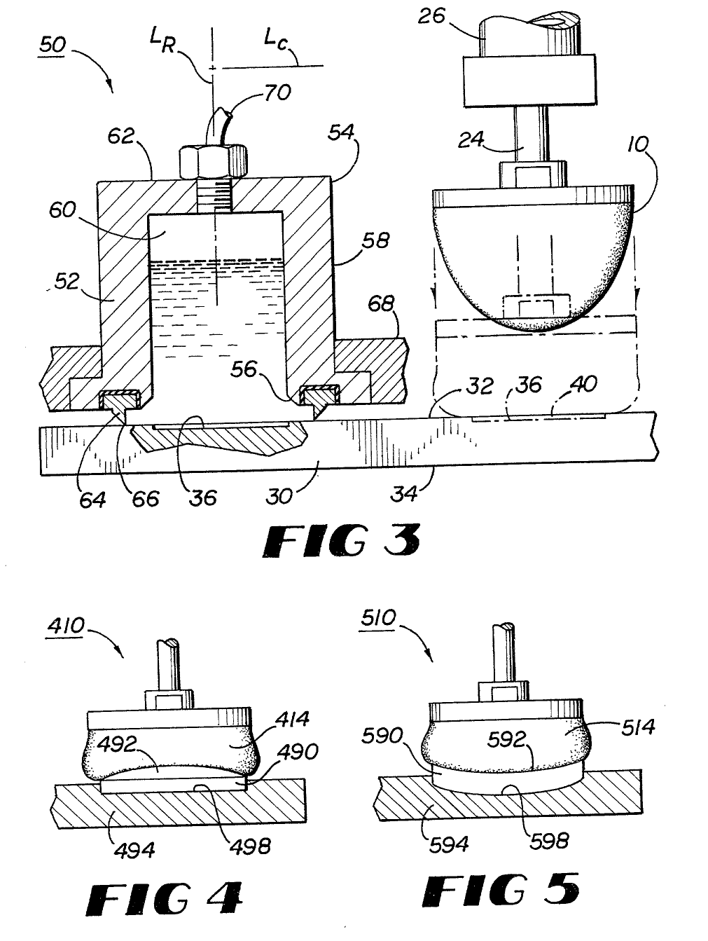

In one embodiment, as shown in FIGS. 3A and 3B, the surface 20 has a cross sectional area in annular and forms a continuous contour from top 18 to bottom 16. The body 14 can be made from deformable materials such as rubber or the like. In other words, the body 14 is deformable when pressed against another object. The body 14 has a surface tension energy that allows it to pick up a layer of coating solution in contact. As best shown in FIG. 3B, the dimension of the base 12 can be represented by a radius r_{b}, and the dimension of the body 14 can be represented by a radius r, which more specifically measures the dimension of the body 14 projecting onto the base 12 at the bottom 16. The radius r is normally smaller than the radius r_{b}, which indicates that the dimension of the base is generally greater than the dimension of the bottom of the body so that the body is adequately supported by the base. However, this is not essential. In other words, the radius r can be substantially equal to or even greater than the radius r_{b}.

The surface of the deformable body can be a seamlessly contour as the surface 20 shown in FIG. 3A. Alternatively, the surface of the deformable body can take other forms. For example, as shown in FIGS. 3C and 3D, the deformable body 314 has an upper portion 321 and a lower portion 323. The lower portion 323 is generally cylindrical or frusto conical defined by a bottom 316 and an upper end 317, where cross-sectionally the lower portion 323 is circular and the radial dimension of the lower portion 323 is gradually increased from the upper end 317 and to the bottom 316. As best shown in FIG. 3D, the dimension of the bottom 316 can be represented by a radius r₁, and the dimension of the upper end 317 can be represented by a radius r₂, where the radius r₁ in general is greater than the radius r₂. Alternatively, the lower portion 323 can be cylindrical, where the radius r₁ is substantially equal to the radius r₂.

The upper portion 321 and the lower portion 323 merger together at the upper end 317 of the lower portion 323. The upper portion 321 has a curved surface 325 that can be characterized by its curvature. Generally speaking, the larger the curvature of surface is, the higher the degree of the surface is curved. The curvature of the curved surface 325 can be chosen as a non-zero value. In the extreme case, the curvature of the curved surface 325 can be chosen as zero, that is, the curved surface 325 becomes flat. In practicing the present invention, the curvature of the curved surface 325 can be chosen by a user to according to the needs. For example, if the optical surface to be coated is concave, one may choose a deformable body having a surface that is more “flat,” i.e., has a small curvature so that the deformable body may make a good contact with the optical surface. On the other hand, if the optical surface to be coated is convex, one may choose a deformable body having a surface that is more “curved,” i.e., has a larger curvature so that the deformable body may make a good contact with the convex optical surface. However, because it is deformable, a deformable body with a given curvature can be utilized to make a contact with an optical surface with any surface geometry.

Still referring to FIGS. 3C and 3D, the body 314 is supported by a base 312. In the embodiment as shown, the base 312 is a disk that is characterized by radius r_{b}. The radius r_{b} can be smaller, equal to, or larger than radius r₁ that indicates the dimension of the bottom 316. In the embodiment shown in FIGS. 3C and 3D, the radius r_{b} is larger than radius r₁. Thus, the base 312 has an edge portion 327 around the lower portion 323 at the bottom 316. The edge portion 327 may be utilized to handle the transfer pad 310. The edge portion 327 is optional. The thickness of the disk can also be chosen according to a user's needs.

The deformable body can be connected to the base by glue, heat sealing, and the like. The base of the transfer pad can have additional features. For the embodiment shown in FIGS. 3A and 3B, for example, the base 12 has a first side edge 13 and an opposite second side edge 15. The first side edge 13 and the second side edge 15 are located apart but substantially parallel to each other. The first side edge 13 and the second side edge 15 are provided so that the transfer pad 10 can be handled by some mechanical devices. For example, a clamp (not shown) can be utilized to hold and/or transport the transfer pad 10 by engaging the transfer pad 10 at the first side edge 13 and the second side edge 15. Because the first side edge 13 and the second side edge 15 are substantially flat, they can provide bigger and convenient areas for the clamp to engage the transfer pad 10 than an annular disk may offer. Additionally, the corresponding portions at the deformable body 14 can be removed so that larger side edges may be formed (not shown).

Referring now to FIG. 3, an optional transfer pad holder 24 can be mechanically coupled to the base 12 of the transfer pad 10 for handling the transfer pad 10. For example, the transfer pad holder 24 and the base 12 can be coupled together through a nut and bolt coupling mechanism. In one embodiment, the base 12 has a threaded nut portion and the transfer pad holder 24 has a threaded bolt portion matching to the threaded nut portion of the base 12 to couple them together. Other coupling mechanisms can also be utilized. For instance, the transfer pad holder 24 and the base 12 can be molded as an integral piece. The base 12 and the transfer pad holder 24 of the transfer pad 10 are made from same or different materials that have a higher degree of hardness than that of the deformable body 14 of the transfer pad 10. The materials can be used to make the base 12 and the transfer pad holder 24 of the transfer pad 10 include, but not limited to, metal, alloy, ceramic material, plastic material, glass, and the like, respectively.

Additionally, a transfer pad cylinder 26 can be mechanically coupled to the transfer pad holder 24. The transfer pad cylinder 26 can be utilized to position the transfer pad 10 through the transfer pad holder 24. The transfer pad cylinder 26 can also be coupled to control and positioning means or other processing means related to a coating station as shown in FIG. 7.

Referring now to FIGS. 2 and 3, the apparatus 200 also includes a cliche plate 30. Cliche plate 30 has a first surface 32 and an opposite second surface 34, and at least one cliche 36 located at the first surface 32 to contain a coating solution 40. In general, the cliche plate 30 is made from a material that has a higher degree of hardness than that of the body 14 of the transfer pad 10. The material of the cliche plate 30 can be metal, alloy, ceramic material, plastic material, glass, or the like. In one embodiment as shown in FIG. 2, the cliche plate 30 is made from a metal.

Cliche 36 is a recess on the first surface 32 of the cliche plate 30 and sized for containing the coating solution 40, which may be transferred to the transfer pad 10 as discussed in detail below. The cliche 36 can have an annular edge 38 as shown in FIG. 2, or other alternative shapes including oval, elliptic, rectangular, square, polygonal edges, or the like (not shown). Although it is not essential, the cliche 36 may be constructed in match with the transfer pad 10, or vice versa, for convenience. For example, as shown in FIGS. 2 and 3B, the surface 20 of the transfer pad 10 has an annular cross sectional area 22, and the cliche 36 is constructed to have an annular edge 38 accordingly. However, the transfer pad 10 having an annular cross sectional area 22 can work with a cliche having any other geometric shape such as oval, elliptic, rectangular, square, polygonal edges, or the like because the body 14 of the transfer pad 10 is deformable. Likewise, the cliche 36 having an annular edge 38 can work with a transfer pad having a surface with any other geometric shape such as annular, oval, elliptic, rectangular, square, polygonal edges, or the like. Moreover, cliche 36 should not be too deep to have excess coating solution, or too shallow not to have enough coating solution. In general, cliche 36 is a recess having a depth in the range of from 5 microns to 100 microns. For the embodiment shown in FIG. 2, cliche 36 is a recess having a depth of approximately 15 to 20 microns. Furthermore, cliche 36 can have different sizes in term of dimension constant d_{c}. Dimension constant d_{c} is in the range of 1 to 50 cm. For the embodiment shown in FIG. 2, where the cliche 36 has anannular edge 38, d_{c} is the diameter of the annular edge 38 and is in the range of 5 to 15 cm. Moreover, cliche plate 30 may have a plurality of cliches that can be same or different from each other (not shown). Furthermore, cliche plate 30 may have at least one or a plurality of cliches on the second surface 34 that can be same or different from each other (not shown).

Coating solution 40 filling the cliche 36 of the cliche plate 30 may come from a reservoir that contains the coating solution. In the embodiment as best shown in FIGS. 2 and 3, reservoir 50 has a body 52 with a first end 54 and a second end 56, an outer surface 58 and a longitudinal axis L_{R}. The reservoir 50 defines an axially extending bore 60. A cap 62 closes the extending bore 60 at the first end 54, and a wiper blade 64 is positioned surrounding the extending bore 60 at the second end 56. The wiper blade 64 has a blade edge 66, which is sized to encircle the cliche 36 when the reservoir 50 is positioned over the cliche 36 so as to separate the bore 60 from the ambient air. In use, when the reservoir 50 is positioned with its second end 56 against the first surface 32 of the cliche plate 30, the cliche plate 30 cooperates with the wiper blade 64 to close the extending bore 60 at the second end 56 so that coating solution 40 is contained therein. A washer 68 is fitted at the second end 56 outside the outer surface 58 of the body 52. The washer 68 can protect the wiper blade 64 including the blade edge 66 and may further seal the bore 60.

Additionally, the reservoir 50 can have an inlet 70 through the cap 62. The inlet 70 is in fluid communication with the bore 60 and a supply (not shown) of the coating solution 40. The coating solution 40 can be provided to the bore 60 of the reservoir 50 from the supply of the coating solution through the inlet 70.

Moreover, a cliche indexing cylinder 80 is coupled to the cliche plate 30. The cliche indexing cylinder 80 can be utilized to move, control and position the cliche plate 30. The cliche indexing cylinder 80 may be coupled to control and positioning means or other processing means related to a coating station as shown in FIG. 7.

In one embodiment, as best shown in FIGS. 2 and 3, the cliche plate 30 can be moved relative to the reservoir 50 in a direction, denoted as axis L_{c}, substantially perpendicular to the longitudinal axis L_{R} of the reservoir 50 so that the wiper blade 66 crosses the cliche 36 to leave some of the coating solution 40 in the cliche 36, which may be picked up by the deformable body 14 of the transfer pad 10 upon contact.

The coating solution is applied to an optical surface of an optical device such as an optical lens, or an optical mold that can be utilized to cast an optical lens. As shown in FIG. 2, an optical device 90 with an optical surface 92 is positioned on and supported by a lens indexing plate 94 such that the optical surface 92 is facing away from the lens indexing plate 94 and can be contacted by a transfer pad 10. A lens plate indexing cylinder 96 is coupled to the lens indexing plate 94. The lens plate indexing cylinder 96 can be utilized to move, control and position the lens indexing plate 94 so as to move, control and position the optical device 90.

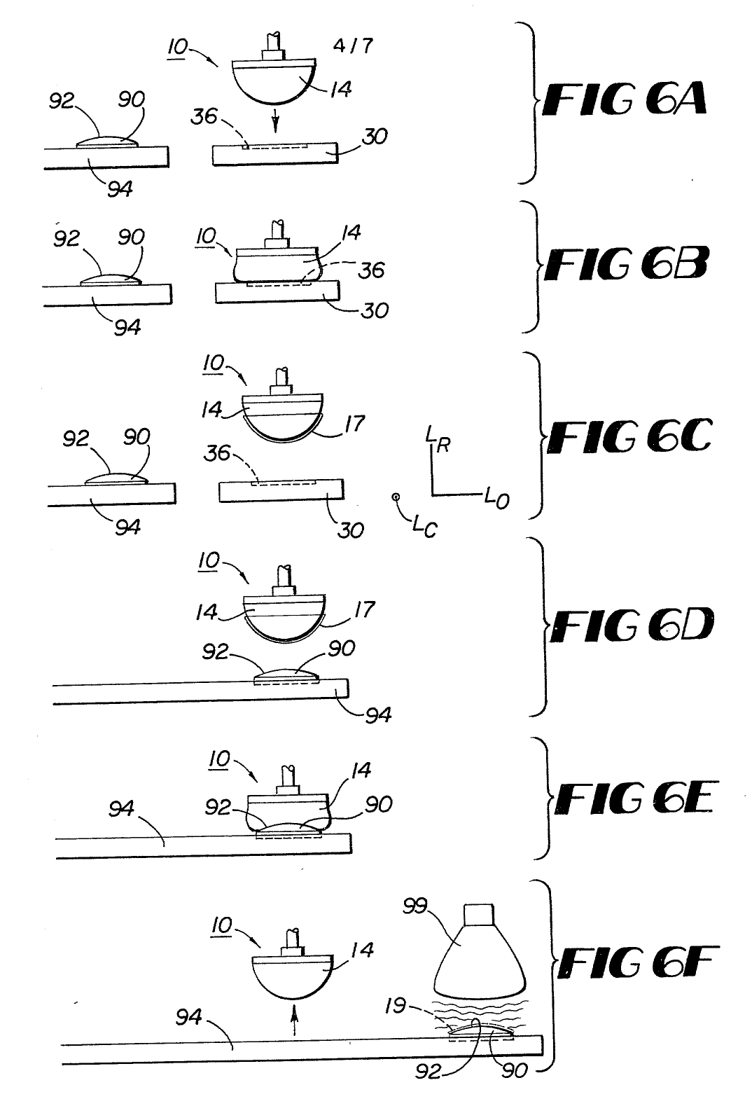

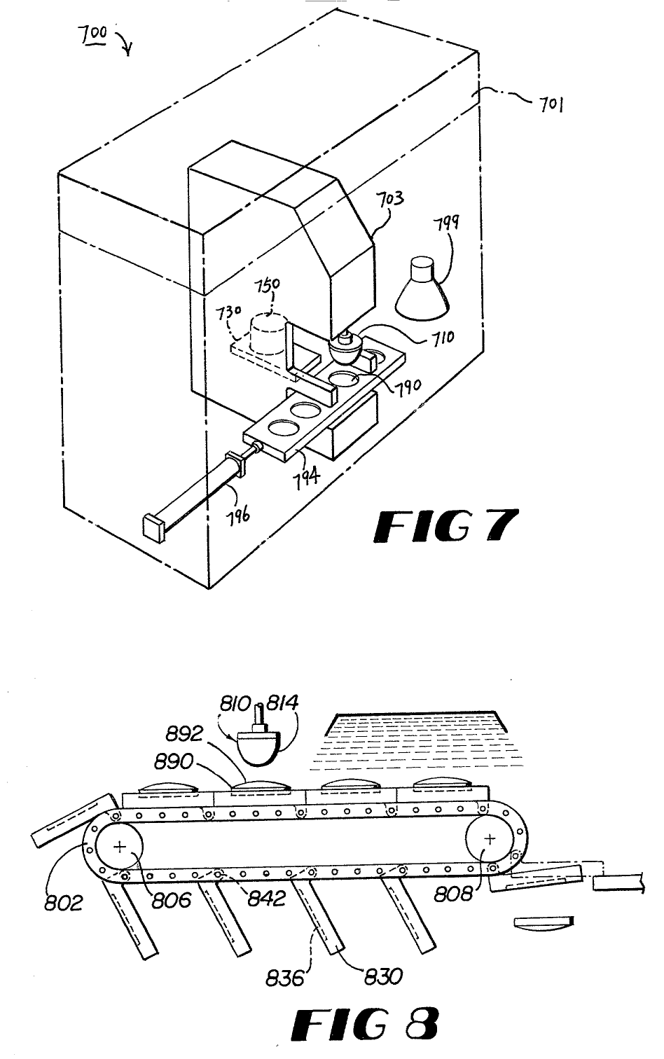

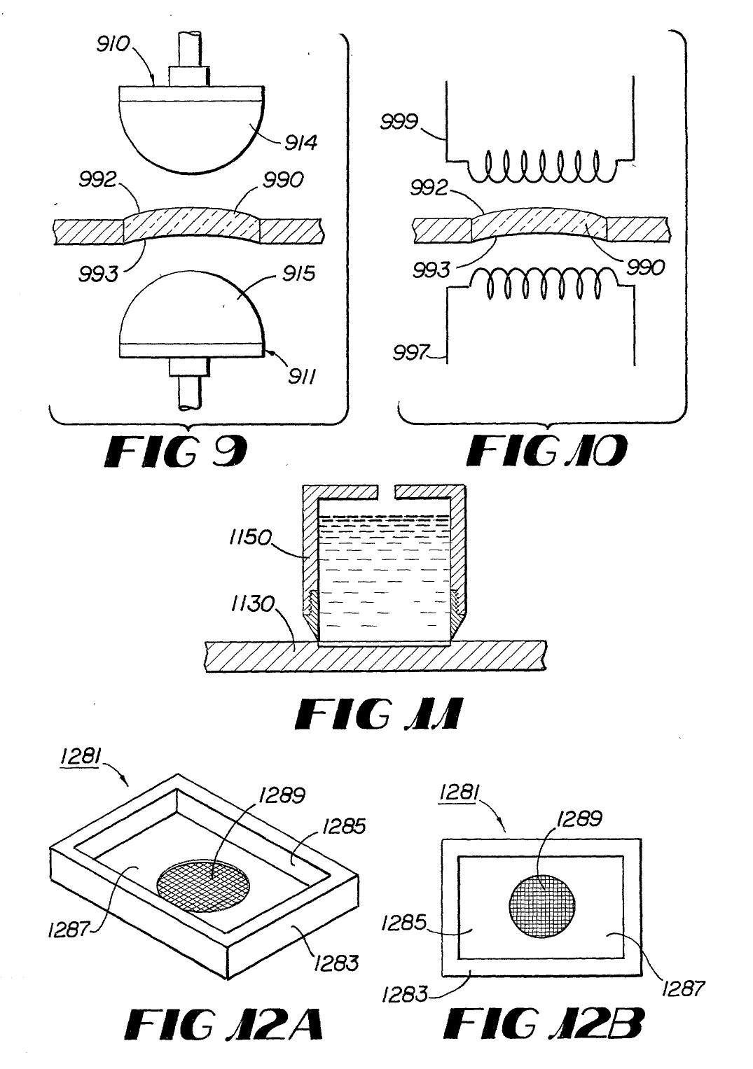

Optionally, a lens indexing plate may have a recess to receive an optical device. For examples, as shown in FIG. 4, a lens indexing plate 494 may have a recess 498 that is annular and has a flat bottom to receive an optical device 490 having a concave optical surface 492. The optical device 490 is received in the recess 498 such that the concave optical surface 492 is facing away from the lens indexing plate 494 and can be contacted by a transfer pad 410 with its deformable body 414. Alternatively, as shown in FIG. 5, a lens indexing plate 594 may have a recess 598 that is annular and has a convex bottom to receive an optical device 590 having a convex optical surface 592. The optical device 590 is received in the recess 598 such that the convex optical surface 592 is facing away from the lens indexing plate 594 and can be contacted by a transfer pad 510 with its deformable body 514. Note that if an optical device has a convex optical surface and a substantially flat back surface, the optical device can also be supported by the lens indexing plate 494. Additionally, a lens indexing plate may have several recesses, each being able to receive an optical device. The recesses may be different or the same.

In addition, referring now back to FIG. 2, the apparatus 200 may include an energy source 99 for irradiating a beam of energy onto the optical surface 92 to treat the coating solution to form the coating on the optical surface 92. The energy source 99 can include a microwave energy source such as a microwave oven, an infra-red (“IR”) light, an ultra-violet (“UV”) light, other type of energy sources, or any combination of them. As discussed in further detail below, one aspect of the present invention is that, after coating solution is applied to an optical surface, the optical surface with the coating solution is first irradiated with radiation from a microwave energy source, and subsequently cured by UV light, IR light, or a combination of them. This process provides a surprisingly high quality of coating. The microwave radiation can be provided by a microwave oven.

The apparatus 200 can be placed in an air filtration system to form an integrated coating station or system. As shown in FIG. 7, an integrated apparatus 700 includes a coating station 703 where an optical device 790 can be processed. The apparatus 700 further includes a transfer pad 710, a cliche plate 730, a reservoir 750, a lens indexing plate 794 with a lens plate indexing cylinder 796, and an energy source 799. Each of them has been described above and is placed inside the air filtration system 701, which includes a properly sealed cabinet that is controlled under a slightly positive atmosphere than that of the surrounding to repel dusts and dirts. A computer (not shown) can be utilized to control and coordinate the operation of the coating apparatus 200, 700, or the like.

### Methods of Applying a Coating of the Present Invention

Referring now to FIGS. 2-11, methods of applying a coating to an optical surface of an optical device according to the present invention are described.

In operation, as shown in the embodiment of FIGS. 2, 3 and 6A-6F, coating solution 40 is placed in a cliche 36 of a cliche plate 30. In doing so, a reservoir 50 containing the coating solution 40 is provided and positioned with its second end 56 against the first surface 32 of the cliche plate 30, the cliche plate 30 cooperates with the wiper blade 64 to close the extending bore 60 at the second end 56. The cliche plate 30 is moved relative to the reservoir 50 in direction L_{c}, which substantially perpendicular to the longitudinal axis L_{R} of the reservoir 50, so that the wiper blade 66 crosses the cliche 36 to leave some of the coating solution 40 in the cliche 36. Referring to FIG. 11, the relative motion can be accomplished in at least two ways. The first option is to keep the cliche plate 1130 stationary, and move the reservoir 1150 in a relative motion to fill the cliche with coating solution. Alternatively, the second option is to keep the reservoir 1150 stationary, and move the cliche plate 1130 in a relative motion to fill the cliche with coating solution. Each of them can be satisfactorily utilized to practice the present invention. In the description below, for definiteness, the second option is chosen. In this embodiment, the cliche plate 30 is moved from a retracted position or a first position, which is the position underneath the reservoir 50, to a working position or second position, which is the position underneath the transfer pad 10. The motion of the cliche plate 30 can be controlled by the cliche indexing cylinder 80. Now the cliche plate 30 has some coating solution 40 in its cliche 36.

Referring now to FIGS. 6A-6F, once the cliche plate 30 having coating solution in its cliche 36 is positioned underneath the transfer pad 10 and in alignment with the transfer pad 10 along the axis L_{R}, wherein the transfer pad 10 initially is at a home position or first position that is above the second position, the transfer pad 10 and the cliché plate 30 are brought together in a first relative movement so that the transfer pad 10 contacts the coating solution in the cliche 36. In the embodiment as best shown in FIG. 6A, it means that the transfer pad 10 moves down from its home position into the second position to contact with the cliche plate 30. The transfer pad 10 is pressed against the cliche 36 of the cliche plate 30 so that the deformable body 14 is deformed and some coating solution is transferred from the cliche 36 to form a layer 17 of the coating solution on the surface 20 of the deformable body 14 as shown in FIGS. 6B and 6C. The transfer pad 10 and the cliche plate 30 are then separated from each other in a second relative movement so that the transfer pad 10 is substantially back to its home position and the cliche plate 30 is substantially back to or stays at the second position. In the embodiment as best shown in FIG. 6C, it means that the transfer pad 10 moves up to its home position along the axis L_{R}, and the cliche plate 30 retracts to its retracted position, which is underneath the reservoir 50, from the second position along the axis L_{C}. Geometrically speaking, the second position and cliché plate 30's retracted position are aligned along the axis L_{C}, the second position and transfer pad 10's home position are aligned along the axis L_{R}, and the axis L_{C} and the axis L_{R} are substantially perpendicular to each other. Thereafter, a coating solution can be placed similarly in the cliche 36 of the cliche plate 30 in the retracted position, and the cliche plate 30 having the coating solution in the cliche 36 may be again positioned in the second position ready for transferring the coating solution to a transfer pad again.

Referring now to FIG. 6D, the lens indexing plate 94 with the optical device 90 moves from its home position along the axis L_{O} into the second position underneath the transfer pad 10 that was previously occupied by the cliche plate 30 and in alignment with transfer pad 10 along the axis L_{R}. As shown in FIG. 6E, the transfer pad 10 and the lens indexing plate 94 are brought together in a relative movement so that the transfer pad 10 contacts the optical device 90 to transfer the layer 17 of coating solution to the optical surface 92. In the embodiment as best shown in FIG. 6E, it means that the transfer pad 10 moves down from its home position into the second position to contact with the optical surface 92. The transfer pad 10 is pressed against the optical surface 92 so that the deformable body 14 is deformed and at least some of the layer 17 of coating solution is transferred from the deformable body 14 to form a layer 19 of the coating solution on the optical surface 92 of the optical device 90. The transfer pad 10 and the lens indexing plate 94 (and hence the optical device 90) are then separated from each other in a relative movement so that the transfer pad 10 is substantially back to its home position. The lens indexing plate 94 is moved to a third position for curing by the radiation energy source 99 as shown in FIG. 6F.

Note that the above description associated with FIGS. 6A-6F gives only one way to apply a coating to an optical surface accordingly to the present invention. Many alternatives are available. For examples, the cliche plate 30 and the lens indexing plate 94 may be kept stationary while the transfer pad 10 is moved to get the coating solution from the cliche plate 30 first and then transfer the coating solution to the optical device 90 positioned on the lens indexing plate 94. The cliche plate 30 and the lens indexing plate 94 may be kept stationary, independently or jointly. Moreover, these motions can be controlled either manually or automatically.

Additionally, as shown in FIGS. 12A-B and 13A-B, a screen 1281 can be placed over the optical surface 92 of the optical device 90 prior to the transfer pad 10 being pressed against the optical surface 92. In one embodiment, the screen 1281 has a frame 1283 defining an opening 1285, which is covered by a film 1287. The film 1287 in one embodiment is a coated fibre that has an area 1289 where coating is removed. Area 1289 has a plurality or matrix of holes 1291 to allow coating solution to pass through at a controlled rate. The matrix of holes 1291 allows the coating solution to percolate through. When the transfer pad 10 is pressed against the screen 1281, the fibre film 1287 curves to fit the optical surface 92 under the pressure of the deformable body 14 to cause the coating solution from the transfer pad 10 to the screen 1281 to reach the optical surface 92 through the area 1289, which results in a coating layer 19 with a better uniformity as shown in FIG. 14B.

Once a layer 19 of coating solution is applied to the optical surface 92, the coating solution associated with the optical surface 92 is further treated with proper radiation so as to form a coating on the optical surface 92. Radiation treatment includes curing. As one skilled in the art will appreciate, curing can be accomplished in a number of ways. For example, the curing method of the present invention involves exposing the coating solution to an ultraviolet (“UV”) light for a desired time. Alternatively, after exposing the coating solution to UV light, the coating solution is then heated for a predetermined time, such as in an infra-red (“IR”) oven. The IV heating step may further solidify the coating solution to form the hardened coating on the optical surface if not sufficiently cured in the UV step.

One unique aspect of the present invention is that, after coating solution is applied to an optical surface and prior to the UV or IV or both curing step, the optical surface 92 with the layer 19 of coating solution is first irradiated with microwave radiation. This microwave radiation heats up the coating solution and the associated optical surface, hardens the coating solution and provides a surprisingly high quality of coating on the optical surface, which is smoother, finer and more uniform than a coating cured by previous known UV or IV or both curing methods without using microwave radiation first. As shown schematically in FIG. 14B, the radiation treatment of the coating layer 19 at a wavelength of microwave prior to curing yields a coating layer 19 with a surface 1419 that is smooth and eliminates the orange-peel like effect as shown in FIG. 14A. Although we do not intend to be bound by any theory of operation, we note that one possible mechanism may be due to the motion of the molecules of the coating solution encouraged by the microwave radiation to fill the holes between the drops of the coating solution. The microwave energy is not strong enough to harden the coating layer as rapidly as UV or IV radiation. The microwave radiation can be provided by a microwave oven. Note that utilizing microwave radiation to irradiate an optical surface with coating solution provided by the present invention can be practiced no matter how the coating solution is applied to the optical surface.

Thus, in summary, in another aspect, the present invention provides a method for applying a coating to applying a coating to an optical surface of an optical lens. In one embodiment, the method includes the steps of placing a coating solution in a cliche of a cliche plate, transferring the coating solution from the cliche to a transfer pad, pressing the transfer pad to the optical surface so as to transfer the coating solution from the transfer pad to the optical surface, irradiating the coating solution associated with the optical surface at a wavelength of microwave so as to form a coating layer on the optical surface, and curing the coating layer to form a coating on the optical surface by radiation outside the wavelength range of microwave such as UV or IV radiation.

In yet another aspect, the present invention provides a method for applying a coating to at least one optical surface of a mold. In one embodiment (not shown), the method includes the steps of placing a coating solution in a cliche of a cliche plate, transferring the coating solution from the cliche to a transfer pad, providing a front mold and a back mold each having a facing inside surface, pressing the transfer pad to each of the facing inside surfaces of the front mold and back mold so as to transfer the coating solution from the transfer pad to each of the facing inside surfaces, respectively, irradiating the coating solution associated with each of the facing inside surfaces at a wavelength of microwave as discussed above so as to form a coating layer on each of the facing inside surfaces, positioning the front mold and the back mold whose facing inside surfaces are a negative image of the surfaces of an optical lens to be formed at a proper distance and rotational orientation relative to each other, both the front mold and back mold having an edge, closing the edges of the front mold and back mold with a closure member to define a molding cavity, injecting a fluid lens-forming material into the molding cavity, and curing the fluid lens-forming material by radiation outside the wavelength range of microwave so that the fluid lens-forming material is hardened to form the optical lens and each of the coating layers on the inside surfaces of the front mold and back mold is transferred to and hardened to be bond on a corresponding surface of the optical lens. The closure member can be a gasket, a sleeve, or a wrap.

The whole process of applying a coating solution to an optical surface can be automated. In one embodiment as shown in FIG. 8, a plurality of lens indexing plates 830 are moved along a transfer belt 804, which is driven by rollers 806, 808 associated with revolving stage 802. Each of the plurality of lens indexing plates 830 is positioned with the transfer belt 804 through a holding means 842 and is loaded with an optical device 890 with an optical surface 892 at area 1. Coating solution is then transferred from the deformable body 814 of a transfer pad 810 to the optical surface 892 by pressing the deformable body 814 against the optical surface 892 at area 2. At area 3, the optical surface 892 with the applied coating solution is first irradiated with microwave radiation and then cured with UV and/or IV light. At area 4, the optical device 890 with cured coating on the optical surface 892 is unloaded for further processing. The lens indexing plates 830 may be different or the same, and each of them can be loaded with a different or identical optical device for coating.

Referring now to FIGS. 9 and 10, the present invention can be utilized to apply coating solution to an optical device 990 having two optical surfaces 992, 993. In one embodiment, coating solution is picked up by a first transfer pad 910 and a second transfer pad 911. The optical device 990 is positioned between the first transfer pad 910 and the second transfer pad 911. Then the first transfer pad 910 is pressed against the first optical surface 992, and the second transfer pad 911 is pressed against the second optical surface 993, respectively, so as to transfer the coating solution from the first transfer pad 910 and the second transfer pad 911 to the first optical surface 992 and the second optical surface 993, respectively. As shown in FIG. 10, a first radiation energy source 999 and a second radiation energy source 997 can be utilized to irradiate the first optical surface 992, and the second optical surface 993, respectively. Each of the first radiation energy source 999 and the second radiation energy source 997 can include a microwave energy source such as a microwave oven, an infra-red (“IR”) light, an ultra-violet (“UV”) light, other type of energy sources, or any combination of them.

A variety of coating solutions such as coating inks and sol-gel mixtures(s) can be used to practice the present invention. In particular, coating inks GB-155 and GB-158 for scratch resistance were successfully used to practice the present invention. Ink GB-155 has the following formulation:

| | | |
|---|---|---|
| EBECRYL-40 (UCB Radcure Inc.) | 56 | g |
| EBCRYL-6040 (UCB Radcure Inc.) | 16 | g |
| TMPTA-N (UCB Radcure Inc.) | 8 | g |
| Irgacure 907 (Ciba Specialty Chem.) | 1.0 | g |
| Triphenylphosphine (Aldrich Chem. Co., Inc) | 1.2 | g |
| Diphenyl[2,4,6-trimethylbenzoyl] | 0.32 | g |
| phosphineoxide (Aldrich Chem. Co. Inc.) | | |
| Fluorad FC-430 (3M Specialty Chem. Div.) | 0.8 | g |

The viscosity of GB-155 was measured with a Canon-Fenske Capillary Viscometer, providing a value of 698 cSt (centistokes).

Additionally, Ink GB-158 has the following formulation:

| | | |
|---|---|---|
| EBECRYL-40 | 61 | g |
| EBCRYL-6040 | 11 | g |
| EBCRYL-3720-TP40 | 17 | g |
| TMPTA-N | 11 | g |
| Irgacure 907 | 1.0 | g |
| Triphenylphosphine | 1.2 | g |
| Diphenyl[2,4,6-trimethylbenzoyl] | 0.32 | g |
| phosphineoxide | | |
| Fluorad FC-430 | 0.8 | g |

The viscosity of GB-158 was measured with a Canon-Fenske Capillary Viscometer, providing a value of 409 cSt.

Several comparison studies have been made according to the present invention as shown below.

### EXPERIMENT 1

### Applying a Coating to a Mold Without Microwave Radiation

Preparation: The coating ink GB-155 was used for this experiment. The method for applying a coating to at least one optical surface of a mold as discussed above was used. A cliche plate with a cliche having a depth of 15 microns was used. After a layer of coating ink GB-155 was applied to the facing inside surface of the mold, the coating was half cured with UV radiation fro 30 seconds.

Results: The coating has good scratch resistance, but it has an orange-peel like surface.

### EXPERIMENT 2

### Applying a Coating to a Mold With Microwave Radiation

Preparation: Same as Experiment 1 except that the mold with applied coating solution was first placed in a microwave oven and irradiated (i.e., heated) with full power (700W) for 1 minute, then cured with UV radiation fro 30 seconds.

Results: The coating has good scratch resistance with a smooth surface.

### EXPERIMENT 3

### Applying a Coating to a Mold With a Different Cliche

Preparation: Same as Experiment 2 except that a cliche plate with a cliche having a depth of 20 microns instead of 15 microns was used.

Results: The scratch resistance of the coating was improved that might be due to the coating thickness increased.

### EXPERIMENT 4

### Applying a Coating to a Mold With a Different Coating Ink

Preparation: Same as Experiment 2 except that coating ink GB-158, which has small value of viscosity than coating ink GB-155, was used.

Results: The scratch resistance of the coating was weaker that might be due to the coating thickness decreased.

### EXPERIMENT 5

### Applying a Coating to a Lens Without Microwave Radiation

Preparation: The coating ink GB-155 was used for this experiment. The method for applying a coating to an optical surface of a lens as discussed above was used. A cliche plate with a cliche having a depth of 15 microns was used. After a layer of coating ink GB-155 was applied to the facing inside surface of the mold, the coating was half cured with UV radiation fro 30 seconds.

Results: The coating has good scratch resistance, but it has an orange-peel like surface.

### EXPERIMENT 6

### Applying a Coating to a Lens With Microwave Radiation

Preparation: Same as Experiment 5 except that the lens with applied coating solution was first placed in a microwave oven and irradiated (i.e., heated) with full power (700W) for 1 minute, then cured with UV radiation fro 30 seconds.

Results: The coating has good scratch resistance with a smooth and more uniform surface.

Although the present invention has been described with reference to specific details of certain embodiments thereof, it is not intended that such details should be regarded as limitations upon the scope of the invention except as and to the extent that they are included in the accompanying claims.

What is claimed is:

1. A method for applying a coating to an optical surface of an optical device, comprising the steps of:
a. placing a coating solution in a cliche of a cliche plate;
b. transferring the coating solution from the cliche to a transfer pad, wherein the transfer pad has a deformable body retaining coating solution; and
c. pressing the transfer pad to the optical surface so as to transfer the coating solution from the deformable body of the transfer pad to the optical surface.

2. The method of claim 1, further comprising the step of:
d. irradiating the coating solution associated with the optical surface at a wavelength of microwave so as to form a coating layer on the optical surface.

3. The method of claim 1, wherein the placing step comprises:
i. providing a reservoir containing the coating solution; and
ii. filling the cliche of the cliche plate with the coating solution from the reservoir.

4. The method of claim 3, wherein the reservoir has a body with a first end and a second end, an outer surface and a longitudinal axis, and defining an axially extending bore, a cap closing the extending bore at the first end, and a wiper blade surrounding the extending bore at the second end, and the filling step further comprises the steps of:
iii. positioning the reservoir with its second end against the surface of the cliche plate having the cliche such that the cliche plate cooperates with the wiper blade to close the extending bore at the second end; and
iv. moving the cliche plate relative to the reservoir in a direction substantially perpendicular to the longitudinal axis so that the wiper blade crosses the cliche to leave some of the coating solution in the cliche.

5. The method of claim 4, wherein the reservoir further has an inlet through the cap and in fluid communication with the bore and a supply of the coating solution, further comprising the step of providing the coating solution to the bore of the reservoir from the supply of the coating solution through the inlet.

6. The method of claim 1, wherein the transferring step comprises:
i. placing the transfer pad in a first position;
ii. positioning the cliche plate in a second position, wherein the first position and the second position are aligned along a first operating axis;
iii. bringing the transfer pad and the cliche plate together in a relative movement so that the transfer pad contacts the coating solution in the cliche;
iv. pressing the transfer pad against the cliche plate so that some coating solution is transferred from the cliche to form a layer of the coating solution on the transfer pad;
v. separating the transfer pad and the cliche plate from each other in a relative movement so that the transfer pad is substantially back to the first position and the cliche plate is substantially back to or stays at the second position; and
vi. retracing the cliche plate to a retracted position from the second position, wherein the second position and the retracted position are aligned along a second operating axis, and the first operating axis and the second operating axis are substantially perpendicular to each other.

7. The method of claim 6, further comprising the steps of:
vii. placing a coating solution in the cliche of the cliche plate in the retraced position; and
viii. positioning the cliche plate having the coating solution in the cliche in the second position ready for transferring the coating solution to the transfer pad.

8. The method of claim 1, wherein the pressing step comprises:
i. placing the transfer pad in a first position;
ii. positioning the optical device in a second position, wherein the first position and the second position are aligned along a first operating axis;
iii. bring the transfer pad and the optical device together in a relative movement so that the transfer pad contacts the optical surface of the optical device;
iv. pressing the transfer pad against the optical surface so that some coating solution is transferred from the transfer pad to form a layer of the coating solution on the optical surface of the optical device; and
v. separating the transfer pad and the optical device from each other in a relative movement so that the transfer pad is substantially back to the first position.

9. The method of claim 8, further comprising the step of:
vi. moving the optical device to a third position for irradiating.

10. The method of claim 2, wherein the radiation is generated by a microwave energy source.

11. The method of claim 10, wherein the microwave energy source is a microwave oven.

12. The method of claim 10, wherein the optical device is an optical lens.

13. The method of claim 12, further comprising the step of curing the smooth coating layer to form a coating on the optical surface by radiation outside the wavelength range of microwave.

14. The method of claim 13, wherein the radiation is generated by an infra-red light source.

15. The method of claim 13, wherein the radiation is generated by an ultra-violet light source.

16. The method of claim 10, wherein the optical device comprises a front mold having a facing inside surface, and the optical surface is the facing inside surface of the front mold.

17. The method of claim 16, wherein the optical device further comprises a back mold having a facing inside surface, and the optical surface is the facing inside surface of the back mold.

18. The method of claim 17, further comprising the steps of:
e. positioning the front mold and the back mold whose facing inside surfaces are a negative image of the surfaces of an optical lens to be formed at a proper distance and rotational orientation to each other, both the front mold and back mold having an edge;
f. closing the edges of the front mold and back mold with a closure member to define a molding cavity;
g. injecting a fluid lens-forming material into the molding cavity; and
h. curing the fluid lens-forming material by radiation so that the fluid lens-forming material is hardened to form the optical lens and each of the coating layers on the inside surfaces of the front mold and back mold is transferred to and hardened to be bond on a corresponding surface of the optical lens.

19. The method of claim 18, wherein the radiation is generated by an infra-red light source.

20. The method of claim 18, wherein the radiation is generated by an ultra-violet light source.

21. The method of claim 1, prior to the pressing step, further comprising the steps of:
i. placing a screen over the optical surface; and
ii. applying coating solution to the screen.

22. The method of claim 21, wherein the pressing step further comprises the step of pressing the transfer pad against the screen so as to transfer the coating solution from the transfer pad to the screen and to the optical surface.

23. The method of claim 22, wherein the screen comprises:
a. a frame defining an opening; and
b. a film covering the opening,
wherein at least part of the film has a plurality of holes.

24. The method of claim 23, wherein the film comprises a partially coated fibre.

25. The method of claim 22, wherein the pressing step further comprises the steps of:
i. pressing the transfer pad against the screen so that the film curvingly fits to the optical surface; and
ii. causing the coating solution from the transfer pad to reach the optical surface through the plurality of holes.

26. A method for applying a coating to an optical surface of an optical device, comprising the steps of:
a. transferring a coating solution to a transfer pad; and
b. pressing the transfer pad to the optical surface so as to transfer the coating solution from the transfer pad to the optical surface.

27. The method of claim 26, further comprising the step of placing a coating solution in a cliche of a cliche plate, and the transferring step comprising the step of transferring the coating solution from the cliche to the transfer pad.

28. The method of claim 27, wherein the placing step comprises:
i. providing a reservoir containing the coating solution; and
ii. filling the cliche of the cliche plate with the coating solution from the reservoir.

29. The method of claim 28, wherein the reservoir has a body with a first end and a second end, an outer surface and a longitudinal axis, and defining an axially extending bore, a cap closing the extending bore at the first end, and a wiper blade surrounding the extending bore at the second end, and the filling step further comprises the steps of:
iii. positioning the reservoir with its second end against the surface of the cliche plate having the cliche such that the cliche plate cooperates with the wiper blade to close the extending bore at the second end; and
iv. moving the cliche plate relative to the reservoir in a direction substantially perpendicular to the longitudinal axis so that the wiper blade crosses the cliche to leave some of the coating solution in the cliche.

30. The method of claim 29, wherein the reservoir further has an inlet through the cap and in fluid communication with the bore and a supply of the coating solution, further comprising the step of providing the coating solution to the bore of the reservoir from the supply of the coating solution through the inlet.

31. The method of claim 26, wherein the transferring step comprises:
i. placing the transfer pad in a first position;
ii. positioning the cliche plate in a second position, wherein the first position and the second position are aligned along a first operating axis;
iii. bringing the transfer pad and the cliche plate together in a relative movement so that the transfer pad contacts the coating solution in the cliche;
iv. pressing the transfer pad against the cliche plate so that some coating solution is transferred from the cliche to form a layer of the coating solution on the transfer pad;
v. separating the transfer pad and the cliche plate from each other in a relative movement so that the transfer pad is substantially back to the first position and the cliche plate is substantially back to or stays at the second position; and
vi. retracting the cliche plate to a retracted position from the second position, wherein the second position and the retracted position are aligned along a second operating axis, and the first operating axis and the second operating axis are substantially perpendicular to each other.

32. The method of claim 31, further comprising:
vii. placing a coating solution in the cliche of the cliche plate in the retracted position; and
viii. positioning the cliche plate having the coating solution in the cliche in the second position ready for transferring the coating solution to a transfer pad.

33. The method of claim 26, wherein the pressing step comprises:
i. placing the transfer pad in a first position;
ii. positioning the optical device in a second position, wherein the first position and the second position are aligned along a first operating axis;
iii. bringing the transfer pad and the optical device together in a relative movement so that the transfer pad contacts the optical surface of the optical device;
iv. pressing the transfer pad against the optical surface so that some coating solution is transferred from the transfer pad to form a layer of the coating solution on the optical surface of the optical device; and
v. separating the transfer pad and the optical device from each other in a relative movement so that the transfer pad is substantially back to the first position and the optical device is substantially back to or stays at the second position.

34. The method of claim 33, further comprising:
vi. moving the optical device to a third position for irradiating treatment.

35. The method of claim 26, wherein the optical device comprises an optical lens, further comprising the steps of:
a. irradiating the coating solution associated with the optical surface at a wavelength of microwave so as to form a coating layer on the optical surface; and
b. curing the coating layer to form a coating on the optical surface by radiation outside the wavelength range of microwave.

36. The method of claim 35, wherein the microwave radiation is generated by a microwave energy source.

37. The method of claim 35, wherein the radiation outside the wavelength range of microwave is generated by at least one of an infra-red light and an ultra-violet light.

38. The method of claim 26, wherein the optical device comprises a front mold having a facing inside surface, and the optical surface is the facing inside surface of the front mold.

39. The method of claim 38, wherein the optical device further comprises a back mold having a facing inside surface, and the optical surface is the facing inside surface of the back mold.

40. The method of claim 39, further comprising the steps of:
a. irradiating the coating solution associated with the facing inside surface for each of the front mold and back mold at a wavelength of microwave so as to form a coating layer on each facing inside surface;
b. positioning the front mold and the back mold whose facing inside surfaces are a negative image of the surfaces of an optical lens to be formed at a proper distance and rotational orientation relative to each other, both the front mold and back mold having an edge;
c. closing the edges of the front mold and back mold with a closure member to define a molding cavity;
d. injecting a fluid lens-forming material into the molding cavity; and
e. curing the fluid lens-forming material by radiation outside the wavelength range of microwave so that the fluid lens-forming material is hardened to form the optical lens and each of the coating layers on the inside surfaces of the front mold and back mold is transferred to and hardened to be bond on a corresponding surface of the optical lens.

41. The method of claim 40, wherein the microwave radiation is generated by a microwave energy source.

42. The method of claim 40, wherein the radiation outside the wavelength range of microwave is generated by at least one of an infra-red light and an ultra-violet light.

43. An apparatus for applying a coating to an optical surface of an optical device, comprising:
a. means for containing a coating solution; and
b. means for transferring the coating solution to the optical surface, wherein the transferring means is pressed against the optical surface so as to transfer the coating solution from the transferring means to the optical surface.

44. The apparatus of claim 43, wherein the containing means comprises a cliche plate having a first surface and an opposite second surface, and at least one cliche located at the first surface to contain the coating solution.

45. The apparatus of claim 44, further comprising:
i. means for providing the coating solution; and
ii. means for filling the cliche of the cliche plate with the coating solution from the providing means.

46. The apparatus of claim 45, wherein the providing means includes a reservoir having a body with a first end and a second end, an outer surface and a longitudinal axis, and defining an axially extending bore, a cap closing the extending bore at the first end, and a wiper blade surrounding the extending bore at the second end,
wherein when the reservoir is positioned with its second end against the surface of the cliche plate having the cliche, the cliche plate cooperates with the wiper blade to close the extending bore at the second end, and
wherein the cliche plate can be moved relative to the reservoir in a direction substantially perpendicular to the longitudinal axis so that the wiper blade crosses the cliche to leave some of the coating solution in the cliche.

47. The apparatus of claim 43, further comprising means for irradiating the coating solution associated with the optical surface at a wavelength of microwave so as to form a coating layer on the optical surface.

48. The apparatus of claim 47, wherein the optical device comprises an optical lens, further comprising means for curing the coating layer to form a coating on the optical surface by radiation outside the wavelength range of microwave.

49. The apparatus of claim 48, wherein the microwave radiation is generated by a microwave energy source.

50. The apparatus of claim 48, wherein the radiation outside the wavelength range of microwave is generated by at least one of an infra-red light and an ultra-violet light.

51. The apparatus of claim 47, wherein the optical device comprises a front mold having a facing inside surface, and the optical surface is the facing inside surface of the front mold.

52. The apparatus of claim 51, wherein the optical device further comprises a back mold having a facing inside surface, and the optical surface is the facing inside surface of the back mold.

53. The apparatus of claim 52, further comprising:
a. means for positioning the front mold and the back mold whose facing inside surfaces are a negative image of the surfaces of an optical lens to be formed at a proper distance and rotational orientation to each other, both the front mold and back mold having an edge;
b. means for closing the edges of the front mold and back mold to define a molding cavity;
c. means for injecting a fluid lens-forming material into the molding cavity; and
d. means for curing the fluid lens-forming material by radiation outside the wavelength range of microwave so that the fluid lens-forming material is hardened to form the optical lens and each of the coating layers on the inside surfaces of the front mold and back mold is transferred to and hardened to be bond on a corresponding surface of the optical lens.

54. The apparatus of claim 53, wherein the curing means comprises at least one of an infra-red light and an ultra-violet light.

55. A method for applying a coating to an optical device having a first optical surface and a second optical surface, comprising the steps of:
a. transferring a coating solution to a first transfer pad and a second transfer pad; and
b. pressing the first transfer pad to the first optical surface, and the second transfer pad to the second optical surface, respectively, so as to transfer the coating solution from the first transfer pad and the second transfer pad to the first optical surface and the second optical surface, respectively.

56. The method of claim 55, further comprising the step of placing a coating solution in a cliche of a first cliche plate, and the transferring step comprising the step of transferring the coating solution from the cliche of the first cliche plate to the first transfer pad.

57. The method of claim 56, further comprising the step of placing a coating solution in a cliche of a second cliche plate, and the transferring step comprising the step of transferring the coating solution from the cliche of the second cliche plate to the second transfer pad.

58. The method of claim 57, wherein the placing step comprises:
i. providing a reservoir containing the coating solution; and
ii. filling the cliche of each of the first cliche plate and the second cliche plate with the coating solution from the reservoir.

59. The method of claim 55, wherein the transferring step comprises:
i. placing the first transfer pad in a first position;
ii. positioning the first cliche plate in a second position, wherein the first position and the second position are aligned along a first operating axis;
iii. bringing the first transfer pad and the first cliche plate together in a relative movement so that the first transfer pad contacts the coating solution in the cliche of the first cliche plate;
iv. pressing the first transfer pad against the first cliche plate so that some coating solution is transferred from the cliche to form a layer of the coating solution on the first transfer pad; and
v. separating the first transfer pad and the first cliche plate from each other.

60. The method of claim 59, wherein the transferring step further comprises:
i. placing the second transfer pad in a third position;
ii. positioning the second cliche plate in a fourth position, wherein the third position and the fourth position are aligned along the first operating axis;
iii. bring the second transfer pad and the second cliche plate together in a relative movement so that the second transfer pad contacts the coating solution in the cliche of the second cliche plate;
iv. pressing the second transfer pad against the second cliche plate so that some coating solution is transferred from the cliche of the second cliche plate to form a layer of the coating solution on the second transfer pad; and
v. separating the second transfer pad and the second cliche plate from each other.

61. The method of claim 55, wherein the pressing step comprises:
i. placing the first transfer pad in a first position and the second transfer pad in a second position apart from each other, wherein the first position and the second position are aligned along a first operating axis;
ii. positioning the optical device therebetween the first transfer pad and the second transfer pad;
iii. moving the first transfer pad and the second transfer pad toward each other so that the first transfer pad contacts the first optical surface of the optical device and the second transfer pad contacts the second optical surface of the optical device, respectively; and
iv. pressing the first transfer pad to the first optical surface, and the second transfer pad to the second optical surface, respectively, so as to transfer some coating solution from the first transfer pad and the second transfer pad to the first optical surface and the second optical surface, respectively.

62. The method of claim 55, further comprising the steps of:
a. irradiating the coating solution associated with each optical surface at a wavelength of microwave so as to form a coating layer on each optical surface; and
b. curing the coating layer on each optical surface to form a coating on each optical surface by radiation outside the wavelength range of microwave.

63. The method of claim 62, wherein the microwave radiation is generated by a microwave energy source.

64. The method of claim 62, wherein the radiation outside the wavelength range of microwave is generated by at least one of an infra-red light and an ultra-violet light.

65. A method for applying a coating to an optical surface of an optical lens, comprising the steps of:
a. placing a coating solution in a cliche of a cliche plate;
b. transferring the coating solution from the cliche to a transfer pad;
c. pressing the transfer pad to the optical surface so as to transfer the coating solution from the transfer pad to the optical surface;
d. irradiating the coating solution associated with the optical surface at a wavelength of microwave so as to form a coating layer on the optical surface; and
e. curing the coating layer to form a coating on the optical surface by radiation outside the wavelength range of microwave.

66. The method of claim 65, prior to the pressing step, further comprising the steps of:
i. placing a screen over the optical surface; and
ii. applying coating solution to the screen.

67. The method of claim 66, wherein the pressing step further comprises the step of pressing the transfer pad against the screen so as to transfer the coating solution from the transfer pad to the screen and to the optical surface.

68. A method for applying a coating to at least one optical surface of an optical lens, comprising the steps of:
a. placing a coating solution in a cliche of a cliche plate;
b. transferring the coating solution from the cliche to a transfer pad;
c. providing a front mold and a back mold each having a facing inside surface;
d. pressing the transfer pad to each of the facing inside surfaces of the front mold and back mold so as to transfer the coating solution from the transfer pad to each of the facing inside surfaces, respectively;
e. irradiating the coating solution associated with each of the facing inside surfaces at a wavelength of microwave so as to form a coating layer on each of the facing inside surfaces;
f. positioning the front mold and the back mold whose facing inside surfaces are a negative image of the surfaces of an optical lens to be formed at a proper distance and rotational orientation relative to each other, both the front mold and back mold having an edge;
g. closing the edges of the front mold and back mold with a closure member to define a molding cavity;
h. injecting a fluid lens-forming material into the molding cavity; and
i. curing the fluid lens-forming material by radiation outside the wavelength range of microwave so that the fluid lens-forming material is hardened to form the optical lens and each of the coating layers on the inside surfaces of the front mold and back mold is transferred to and hardened to be bond on a corresponding surface of the optical lens.

69. A method for applying a coating to at least one optical surface, comprising the steps of:
a. transferring a coating solution to the optical surface; and
b. irradiating the coating solution at a wavelength of microwave so as to form a coating layer on the optical surface.

70. The method of claim 69, further comprising the step of curing the coating layer to form a coating on the optical surface by radiation at a wavelength outside the wavelength range of microwave.

71. The method of claim 69, wherein the microwave radiation is generated from a microwave energy source.

72. The method of claim 70, wherein the radiation at a wavelength outside the wavelength range of microwave is generated by at least one of an ultra-violet light and an infra-red light.

73. An apparatus for applying a coating to at least one optical surface, comprising:
a. means for transferring a coating solution to the optical surface; and
b. means for irradiating radiation at a wavelength of microwave so as to form a coating layer on the optical surface.

74. The apparatus of claim 73, further comprising means for curing the coating layer to form a coating on the optical surface by radiation at a wavelength outside the wavelength range of microwave.

75. The apparatus of claim 73, wherein the irradiating means comprises a microwave energy source.

76. The apparatus of claim 74, wherein the curing means comprises at least one of an ultra-violet light and an infra-red light.

77. A method for applying a coating to at least one optical surface, comprising the steps of:
a. placing a screen over the optical surface;
b. applying some coating solution to the screen;
c. transferring some coating solution to a transfer pad;
d. pressing the transfer pad against the screen so as to transfer the coating solution from the transfer pad to the screen and to the optical surface; and
e. irradiating the coating solution so as to form a coating layer on the optical surface.

78. The method of claim 77, wherein the screen comprises:
a. a frame defining an opening; and
b. a film covering the opening,
wherein at least part of the film has a plurality of holes.

79. The method of claim 78, wherein the film comprises a partially coated fibre.
